(19) United States
(12) Patent Application Publication
(10) Pub. No.: US 2004/0251877 A1
(43) Pub. Date: Dec. 16, 2004

(54) Voltage adapter circuit for a lithium ion rechargeable battery

(76) Inventor: Il Sun Lee, Ramsey, NJ (US)

Correspondence Address: Kao H. Lu, 686 Lawson Ave., Havertown, PA, 19083, US

(21) Appl. No.: 10/824,556

(22) Filed: Apr. 14, 2004

Related U.S. Application Data
(60) Provisional application No. 60/478,273, filed on Jun. 13, 2003.

(51) Int. Cl. H02J 7/00

(52) U.S. Cl. 320/136

(57) ABSTRACT

The present invention is a circuit that uses only one pair of bi-directional terminals for both charging and discharging a rechargeable battery. When the circuit detects that the battery is in the charging process, it opens an unrestricted current passage and lets the rechargeable battery fully charge. When the circuit detects the battery is in discharging process, if needed, it will induce a voltage drop of 0.7v and reduce the Li-Ion rechargeable battery's output voltage from 4.2v to desired voltage range 3.3˜3.6v. In addition, the circuit provides a feature that prevents the battery from over-charging or over-discharging.

### CROSS REFERENCE

This application claims priority from U.S. Provisional Patent Application No. 60/478,273 filed on Jun. 13, 2003.

### BACKGROUND OF THE INVENTION

Most digital cameras use a non-rechargeable lithium primary CRV type battery pack. To save money on expensive batteries, customers prefer to use a rechargeable battery pack. Unfortunately, a rechargeable Li-Ion CRV3 battery has more than 300 recycling capacities, and provides output voltage of up to 4.2v. The 4.2v voltage is higher than the regular 3.3˜3.6v voltage output needed by the digital cameras.

There is a need to design a circuit for using the regular Li-Ion rechargeable battery to adjust its regular 4.2v voltage output to the needed 3.3˜3.6v. If a traditional regulator were used to reduce the voltage output, there would have to be two pairs of terminals for the input and output: one terminal would be used for charging the battery, and a second terminal would be used for discharging (providing the power to the camera). This invention however, uses only one pair of terminals for charging or recharging.

### BRIEF SUMMARY OF THE INVENTION

The present invention is a circuit that uses only one pair of bi-directional terminals for both charging and discharging, thus it simplifies the overall operation of the camera. The circuit detects when the battery is in the charging or in discharging process, and then controls the current flow accordingly. Furthermore, the circuit will induce a voltage drop, if needed, in the discharging process, which will make sure that the rechargeable battery outputs a voltage within the required range.

When the circuit detects that the battery is in the charging process, it opens an unrestricted current passage and lets the rechargeable battery fully charge. When the circuit detects the battery is in discharging process, if needed, it will induce a voltage drop of 0.7v and reduce the Li-Ion rechargeable battery's output voltage from 4.2v to desired voltage range 3.3˜3.6v.

In addition, the circuit provides a feature that prevents the battery from over-charging or over-discharging.

### BRIEF DESCRIPTION OF THE DRAWING

The foregoing features the present invention will become more apparent by referring to the following detailed description as well as with the accompanied drawings:

FIG. 1 depicts a circuit that regulates the voltage outputs between Li-Ion rechargeable battery and the battery pack during the charging and discharging phase, while providing over-charging/discharging protection.

FIG. 2 shows the logic flow chart to illustrate the operation of the invention.

### DETAILED DESCRIPTION OF THE INVENTION

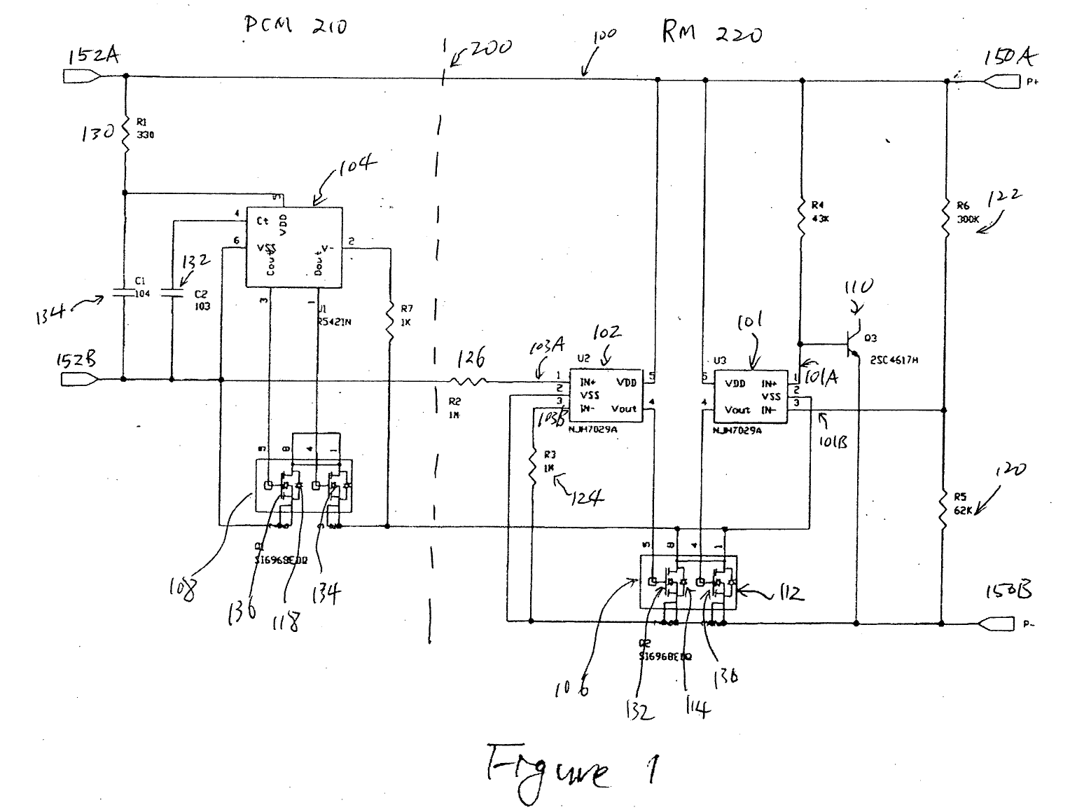

FIG. 1 illustrates an example of the circuit design 100, which is comprised of two modules, delineated by a dot line 200. The first module is a protection circuit module (PCM) 210 and the other module is a regulation module (RM) 220. The PCM 210 provides protection for over-charging/discharging a rechargeable Li-Ion battery from an excess load of current or a large short circuit current. The RM 220 regulates the voltage output of the Li-Ion battery (up to 4.2v) to a desired voltage output range 3.3˜3.6v. The RM 220 also provides an open passage for energy (or current) to the Li-Ion battery in the process of charging. The circuit has only one pair of terminals (P+ 150A and P− 150B) for either battery charging or discharging operation. Thus, the terminals are bi-directional and all charging and discharging are performed through P+ 150A and P− 150B. The circuit can maintain the output voltage level at 3.3˜3.6v continuously with function of two OP Amps (U2 102 and U3 101) and voltage dropping of diodes 112 and 114 (two inside MOSFET Q2 106).

The circuit and a Li-Ion rechargeable battery make up a battery pack in various forms. As long as the Li-Ion rechargeable battery is connected with the voltage adjustment circuit at C+ 152A and C− 152B, the circuit can be an add-on peripheral installed between the camera and the battery, or the circuit can be built into the battery. Other arrangements between the circuit and the battery are also plausible.

Referring back to FIG. 1, the OP AMP U2 102 detects whether the battery is in input mode, output mode or stand-by mode (i.e. charging, discharging or doing nothing). This can be done by comparing the voltage difference between its pin 1 (IN+) 103A and its pin 3 (IN−) 103B. The device then turns on or off the first FET 132 in MOSFET Q2 106 accordingly. The OP AMP U3 101 controls the second FET 130 in MOSFET Q2 106 by comparing the divider voltage of R5 120, R6 122 with the band-gap voltage of transistor Q3 110, also known as the basic voltage. The OP AMP U3 101 turns off the FET 130 if the divider voltage is higher than the basic. Or it turns on the FET 130 if the divider voltage is lower than the basic voltage. The combination of these components of this circuit will maintain an output at P+ 150A and P− 150B in the range of 3.3˜3.6v.

In other words, when the battery pack is charging, the voltage of the OP AMP U2 102 pin 1 (IN+) 103A is higher than the voltage of the pin 3 (IN−) 103B, so that an FET 132 in Q2 106 is turned on. Meanwhile, the voltage of the OP AMP U3 101 pin 1(IN+) 101A is lower than the voltage of the pin 3 (IN−) 101B so that the second FET 130 in MOSFET Q2 106 is turned off. The combined result is that MOSFET Q2 is on, since the two FETs 130 and 132 are parallel, and the current can pass the first FET 132 (turned on) unrestrictedly without any voltage drop. Thus, the current passage is completely opened up from terminal P+ 150B through pin 6 of MOSFET 106 to pin 8, then pin 2 of MOSFET 108 to pin 1, then pin 8 to pin 6, and finally to Li-Ion rechargeable battery terminal C− 152B. Assuming no over charging condition occurs, the Li-Ion rechargeable battery becomes fully charged up to 4.2v.

When the battery pack is discharging or supplying power to the camera (outputting), the voltage of the OP AMP U2 102 pin 1 (IN+) 103A is lower than the voltage of the pin 3 (IN−) 103B and the first FET 132 in MOSFET Q2 106 is then turned off. At the same time, the voltage of the OP AMP U3 101 pin 1 (IN+) 101A may be lower or higher than the voltage of the pin 3 (IN−) 101B, depending on whether the output voltage of the pack at P+ 150A and P− 150B is higher or lower than 3.6v. If the output voltage is higher than 3.6v, and the voltage of the OP AMP U3 101 pin 1 (IN+) 101A is less than the voltage of the pin 3 (IN−) 101B, then the second FET 130 is turned off so that both FETs 130 and 132 in MOSFET Q2 106 are turned off. Under this condition, it will force current to pass through two diodes 112 and 114 in MOSFET Q2 106 and lowing the output voltage by 0.7v (voltage drop) to the desired range 3.2˜3.6v. However, if the voltage is lower than 3.6v, and the OP AMP U3 101 pin 1 (IN+) 101A is larger than pin 3 (IN−) 101B and the second FET 130 is turned on, under this condition the circuit will allows current to pass freely through the second FET 130 without any voltage drop. Therefore, during discharging, by either introducing a voltage drop in the aforementioned current passage when the output voltage of the pack is higher than 3.6v or completely opening up the current passage when the output voltage is lower than 3.6v, the circuit maintains overall output voltage of the pack in desired range 3.3˜3.6v.

As mentioned above, the PCM 210 protects the circuit from over-charging/discharging. The Li-Ion battery protector U1 104 controls MOSFET Q1 by turning on/off two FETs 116 and 118 in Q1 108, depending on operating conditions. The protector U1 104 turns on both FETs 116 and 118 in Q1 108 when normal operating condition exists for both charging and discharging. When charging, if the battery voltage becomes greater than 4.35v, because two FETs 134 and 136 are connected in series the protector U1 104 turns off the third FET 136 in MOSFET Q1 104 through pin Cₒᵤₜ104A, where it effectively cuts off the circuit. Then, when the battery voltage drops back below 4.10v the protector U1 104 turns the FET 136 back on and reconnects the circuit.

When discharging, if the battery voltage drops below 2.3v (meaning an excessive current draw) the protector U1 104 turns off the other FET 134 in MOSFET Q1 104 through pin Dₒᵤₜ 104B, effectively cutting off the circuit to protect the battery. But when the battery voltage is back up over 2.9v (or conditions return to normal) the protector U1 104 turns the FET 134 back on and resumes the discharging operation. In addition, whenever the current is greater than 3˜5 A the protector U1 104 turns off the FET 134 which, in turn, cuts off the circuit through pin Dₒᵤₜ 104B.

In summary, by controlling MOSFET Q1 104 and MOSFET Q2 106, the OP AMP U1 104, OP AMP U2 102 and OP AMP U3 101 work together to control the passage of current flow with or without a voltage drop depending on whether it is charging or discharging, as well as the discharging voltage level while providing an over-charge/discharge protection.

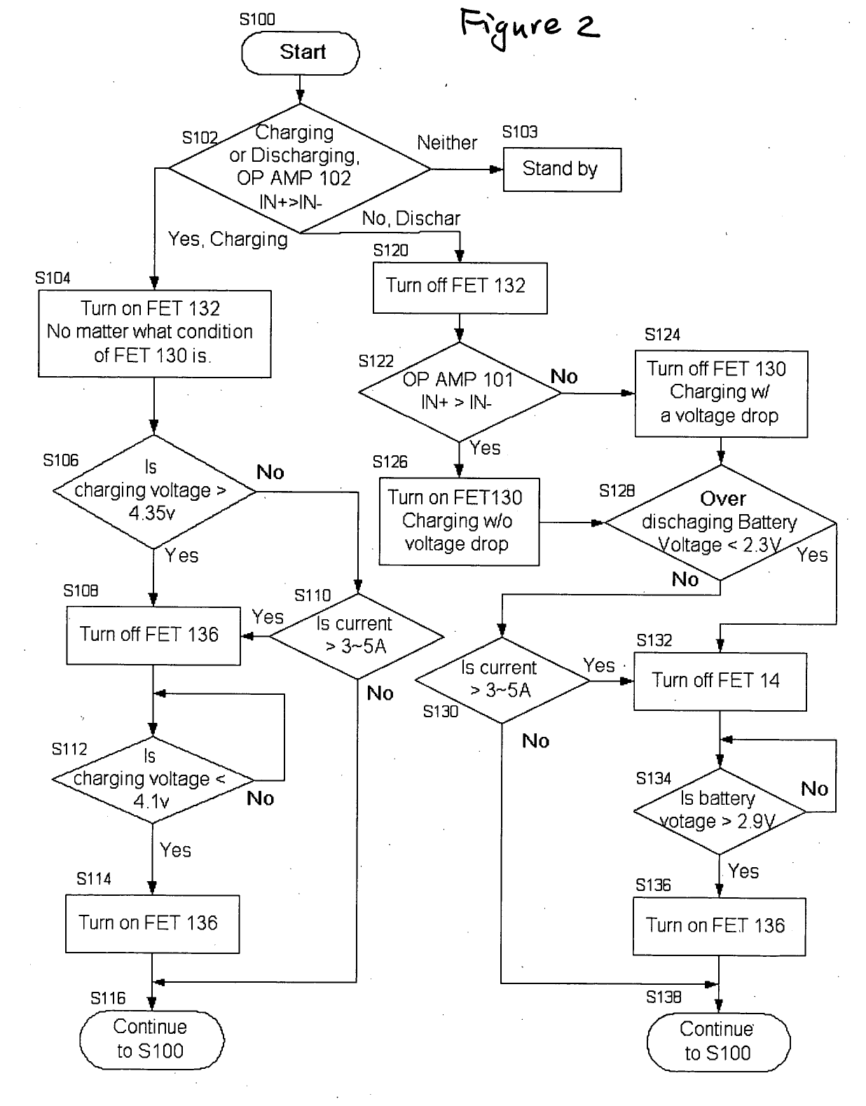

Overall, FIG. 2 is a logical flow chart to illustrate this invention's operation. Basically the procedure first checks if the battery is under a charging, discharging, or standby condition by comparing the voltage between IN+ 103A and IN− 103B of the OP AMP 102 Step S102. If the voltage of IN+ 103A is larger than the voltage of IN− 103B, then the battery is in charging process and the procedure turns on FET 132, despite what the condition of FET 130 is in step S104. If the voltage of IN+ 103A is less than the IN− 103B, the battery is in discharging process and the procedure turns off FET 132 step S120. Otherwise, the battery is in stand by condition step S103. While charging the battery, the procedure checks if the battery's voltage is higher than 4.35v step S106, if it is then the procedure turns off FET 136 step S108, otherwise, the procedure checks if the current is more than 3-5 A, if it is, the procedure turns off FET 136 in step S108. On the other hand, if the current is less or equal to the 3-5 A, the procedure will continue charging step S116. In step S112, the procedure checks if the charging voltage is decreased to less than 4.1v, if it is, then the procedure turns on FET 136 back on step S114.

Referring back to step S120, where FET 132 is turned off because the battery is in the discharging process. The procedure furtherer checks the voltage difference between IN+ 103A and IN− 103B of the OP APM 101, if the voltage of IN+ 103A is higher than the voltage of IN− 103B, the procedure turns on FET 130 Step S126. Then the procedure goes to step S128. However, if the voltage of IN+ 103A is less than or equal to the voltage of IN− 103B, the procedure turns off FET 130 in step S124. Next, in step 128, the procedure further checks if the voltage of the battery is lower than 2.3v, if it is, then the procedure turns off FET 134 in step S132. Afterwards, the procedure continuously monitors if the voltage of the battery comes back up or over 2.9V, if it is then the procedure turns FET 134 back on step S136. Referring back to step S130, the procedure checks whether the current of the battery is more than 3-5 A, if it is, the procedure goes to step S132. If the current of the battery is less than or equal to 3-5 A then the procedure goes to step S138.

What is claimed is:

1. A voltage adjustment circuit for a Li-ion rechargeable battery comprising:
means for determining by a first comparison circuit whether the rechargeable battery is in a charging state, a discharging state or a stand-by state, and the first comparison circuit turns on or off a first switching element accordingly;
means for comparing by a second comparison circuit, during the battery is in a discharging state, the voltages between an input voltage and a reference voltage, and the second comparison circuit turns on or off a second switching element accordingly;
the first compassion circuit coupling to the second comparison circuit, wherein said first switching element is connected with said second switching element in parallel to create two possible passages for the input/output current;
means for protecting the battery by a protection circuit from over-charge/discharge of the battery due to any excess load current or any large short circuit current, where the protection circuit controls a third and a forth switching elements accordingly, and said third switching element is connected with said forth switching element in series, where either said third switching element or said forth switching element will be able to turn off the current passage;
a first pair of bi-directional terminals (P+, P−) are used by both charging(input) operation and discharging(output) operation; and
a second pair of terminals (C+, C−) are used to connect the Li-ion rechargeable battery.

2. The voltage adjustment circuit of claim 1, wherein said first comparison circuit is an OP AMP.

3. The voltage adjustment circuit of claim 1, where the first comparison circuit further comprises a first resistor coupling to the negative end of said second pair of terminals and said first comparison circuit; where a second resistor is coupling to the negative end of said first pair of terminals and said first comparison circuit;
said first resistor providing a first input signal and appropriate limit on current to said first comparison circuit from said first terminals; said second resistor provides second input signal and appropriate limit on current to said first comparison circuit from the battery; and
said first comparison circuit compares said first input signal with said second input signal to determine which states the circuit is in; If said first input signal is higher than said second signal, the circuit is in charging state; if said first input signal is lower than said second signal, the circuit is in discharging state; and all other cases are in stand-by state.

4. The voltage adjustment circuit of claim 1, wherein said first switching element is one of FETs in a MOSFET.

5. The voltage adjustment circuit of claim 1, wherein said second comparison circuit is an OP AMP.

6. The voltage adjustment circuit of claim 1, further comprises a third resistor a transistor, a forth resistor, a fifth resistor, where said third resistor is coupling to the positive end of said first terminals and the base of said transistor, and the emitter of said transistor is coupling to the negative end of said first terminals; said transistor provides one of inputs into said second comparison circuit with a reference voltage at the base of said transistor, using band-gap voltage;
said forth resistor and said fifth resistor are coupling, in series, to said first terminals and divide the voltage (or divider voltage) at said first terminals to provide another input into said second comparison circuit; and
during discharging, said second switch element is controlled by said second comparison circuit to open up the current passage when said reference voltage is higher than said divider voltage, otherwise inducing a voltage drop in the current passage when said reference voltage is lower than said divider voltage.

7. The voltage adjustment circuit of claim 1, wherein said second switching element is one of FETs in a MOSFET.

8. The voltage adjustment circuit of claim 1, wherein said voltage drop is accomplished by adding at least one diode in the current passage, wherein said diode is built in a MOFET.

9. The voltage adjustment circuit of claim 1, wherein said protection circuit is a Li-ion Battery Protector.

10. The voltage adjustment circuit of claim 1, wherein said third switching element and forth switching element are two FETs (third and forth) in a MOSFET;
said protection circuit further has means for detecting an over-charge/discharge condition and provides an appropriate cut-off control signal to said third FET and forth FET;
during charging, when the battery voltage goes higher than 4.35v said protection circuit turns off said third FET to shut off the current passage; when the battery voltage comes down below 4.1v said protection circuit turns on said third FET to reconnect the current passage and resume the charging of the battery;
during discharging, when the battery voltage falls below 2.3v said protection circuit turns off said forth FET to shut off the current passage; when the battery voltage comes back up or over 2.9v said protection circuit turns on said forth FET to reconnect the current passage and resumes the discharging of the battery; and
whenever the current is over 3˜5 A, said protection circuit turns off either the third FET or the forth FET.

11. The voltage adjustment circuit of claim 1, further comprising a sixth resistor, a seventh resistor, a first capacitor, and a second capacitor; wherein said sixth and said seventh resistors provide appropriate signal to said protection circuit while limiting current into said protection circuit;
said first capacitor connects to the negative end of said second terminals and said sixth resistor, and said first capacitor and said sixth resistor will stabilize a supply voltage to the said protection circuit; and
said second capacitor connects to the negative end of said second terminals and said protection circuit, and sets an output delay time for over-charge detection for said protection circuit.
